(19) United States
(12) Patent Application Publication
(10) Pub. No.: US 2010/0087139 A1
(43) Pub. Date: Apr. 8, 2010

(54) AUDIENCE RESPONSE DEVICE, METHOD, AND SYSTEM

(75) Inventor: Michael S. Glass, Conklin, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: FLEETWOOD GROUP, INC., Holland, MI (US)

(21) Appl. No.: 12/556,676

(22) Filed: Sep. 10, 2009

Related U.S. Application Data
(60) Provisional application No. 61/102,619, filed on Oct. 3, 2008.

(51) Int. Cl. H04H 20/71; G06F 3/02; G08B 21/00

(52) U.S. Cl. 455/3.01; 345/169; 340/540

(57) ABSTRACT

An audience response unit may be coupled to a host electronic device, such as a computer, whereby the audience response unit enables information, such as user selections, to be entered via the host electronic device and transmitted by the audience response unit to a base station. The audience response unit can thereby utilize the user-input features and/or the display features of the host electronic device, which may provide greater flexibility of data entry, as well as ease of inputting the information. The use of a host electronic device may also allow reduced sizes and more simplified constructions of the audience response unit to be achieved. The response unit may be incorporated into a Universal Serial Bus (USB) dongle, or other device. The unit effectively turns the host electronic device into a virtual keyboard/audience participation device. Multiple of such units may be incorporated into a system.

### CROSS REFERENCE TO RELATED APPLICATION

The present application claims priority to U.S. provisional application Ser. No. 61/102,619, filed Oct. 3, 2008, by Michael Glass and entitled Audience Response Device, Method, and System, the complete disclosure of which is hereby incorporated herein by reference.

### BACKGROUND OF THE INVENTION

The present invention relates to devices, methods, and systems for gathering information from an audience and transmitting it to a base unit for processing.

Some prior art systems for measuring the response of an audience involve a plurality of dedicated handheld devices, such as keypads, that are distributed to the individual members of the audience. When it is desirable to receive information, the audience members press one or more buttons on the handheld device, which is then wirelessly transmitted by the handheld device to a base station where the information is received. Examples of such prior systems are disclosed in commonly assigned U.S. Pat. No. 5,724,357 entitled Remote Response System and Data Transfer Protocol and issued to Derks, as well as commonly assigned U.S. Pat. No. 5,093,786 entitled Remote Response System and issued to Derks, the complete disclosures of both of which are hereby incorporated by reference herein. Audience response systems, such as these, may be used in a variety of different environments, such as, but not limited to: (1) classroom environments Where the pupils may -provide feedback to the teacher through the handheld devices; (2) lecture or presentation environments where listeners provide feedback regarding the lecture or presentation; (3) retail environments, such as restaurants, where customers may place orders or provide comments on the service using the audience response system; (4) trading environments, such as exchanges, auctions, etc, where it is desirable for individuals to communicate information on bidding, prices, purchases, etc; and (5) other types of environments where information from a group of individuals is desired to be gathered.

### SUMMARY OF THE INVENTION

According to one aspect of the invention, an improved audience response unit is provided that is adapted to be coupled to a host electronic device, such as, but not limited to, a computer, whereby the audience response unit enables information, such as a user selection, to be entered via the host electronic device and transmitted by the audience response unit to a base station. The audience response unit can thereby utilize the user-input features and/or the display features of the host electronic device, which may provide greater flexibility of data entry, as well as ease of inputting the information. The use of a host electronic device may also allow reduced sizes and more simplified constructions of the audience response unit to be achieved.

According to another aspect of the invention, a wireless response system for communicating information, such as user selections, from an audience is provided. The system includes a base unit and a plurality of remote response units that wirelessly communicate the information to the base unit. At least one of the remote response units includes a connector, a program, and a wireless transceiver. The connector is adapted to couple to a port of an electronic device having a display screen, an operating system, and an input device. The program is adapted to be loaded onto the electronic device through the port and to run on the operating system of the electronic device. The program is further adapted to allow a user to input information into the electronic device via the input device and to transfer the information to the remote response unit. The wireless transceiver is adapted to communicate wirelessly with the base unit such that the remote response unit may transmit the information to the base unit through the transceiver.

According to another aspect of the invention, a remote response unit is provided for a wireless response system that processes information, such as user selections, transmitted by an audience member to a base station. The remote response unit includes a connector, a program, and a wireless transceiver. The connector is adapted to couple to a port of an electronic device having a display screen, an operating system, and an input device. The program is adapted to be loaded onto the electronic device through the port and to run in conjunction with the operating system of the electronic device. The program is further adapted to allow the audience member to input the information into the electronic device via the input device and to transfer the information to the remote response unit. The wireless transceiver is adapted to wirelessly transmit the information to the base unit through the transceiver.

According to another aspect of the invention, a method for communicating information, such as user selections, from an audience to a base unit is provided. The method includes providing a remote response unit adapted to wirelessly communicate the information to the base unit; coupling the remote response unit to a port of an electronic device having a display screen, an operating system, and an input device; loading a program from the remote response unit onto the electronic device through the port; inputting the information into the electronic device via the input device; transferring the information to the remote response unit; and wirelessly transmitting the information from the remote response unit to the base unit.

According to other aspects of the invention, the connector may be a Universal Serial Bus (USB) connector and the port on the electronic device may be a USB port. The electronic device may be a personal computer, a notebook computer, a personal digital assistant (PDA), a cell phone, or any other known or future developed electronic device having a display, a port, an input device, and an operating system. The remote response unit may include a keypad such that a user can enter the information into it and transmit the information to the base station without having to connect the remote response unit to the electronic device.

### BRIEF DESCRIPTION OF THE DRAWINGS

FIG. 1 is a block diagram of an illustrative embodiment of an audience response system according to one aspect of the present invention;

FIG. 2 is a block diagram of an illustrative embodiment of a remote response unit; and

FIG. 3 is an alternative embodiment of an audience response system.

### DETAILED DESCRIPTION OF THE EMBODIMENTS

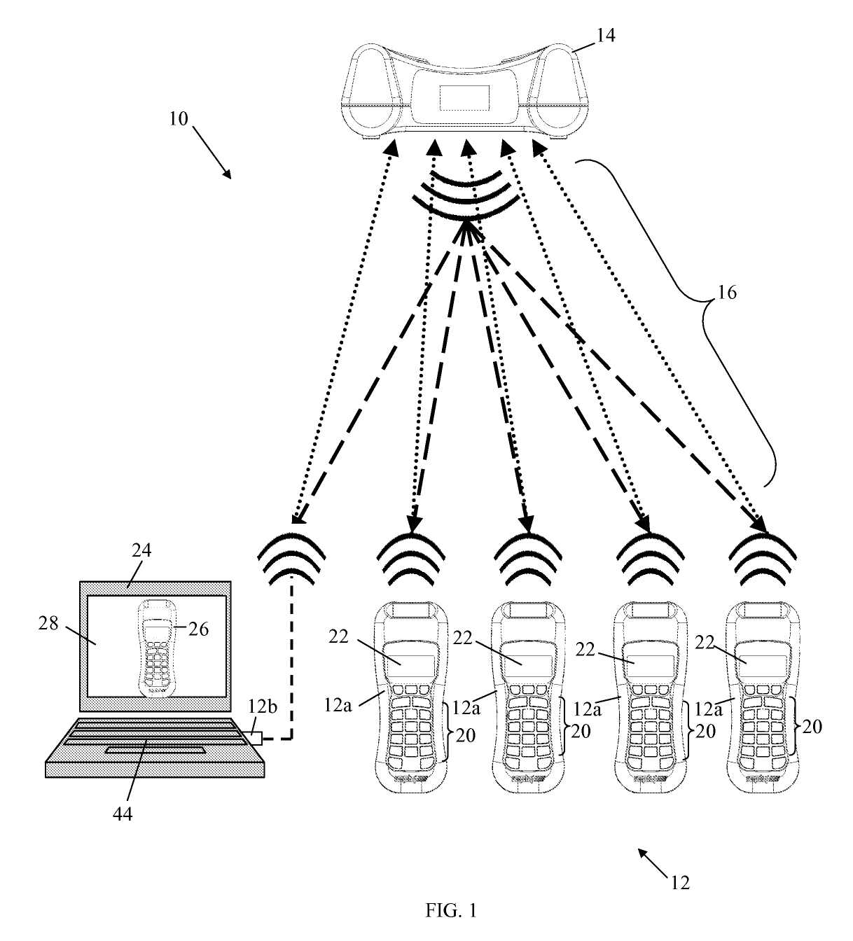

An illustrative example of an audience response system 10 according to one embodiment is depicted in FIG. 1. Audience response system 10 includes a plurality of remote response units 12 that wirelessly communicate with a base station 14. Remote response units 12 may be of a plurality of different kinds. In the embodiment of FIG. 1, remote response units 12 include a plurality of different types of response units, such as stand-alone or nonlinkable remote response units 12a and linkable remote response units 12b. The differences between non-linkable remote response units 12a and linkable remote response units 12b will be discussed in greater detail below. Both linkable and non-linkable remote response units 12b and 12a wirelessly communicate with base station 14 via a wireless communications connection 16. Wireless communication connection 16 may be a radio frequency (RF) communications connection, an infrared communication connection, or it may be any other suitable wireless communication connection. In one embodiment, communication connection 16 may operate according to the communications protocols set forth in commonly assigned U.S. Pat. No. 5,724,357 issued to Derks and entitled REMOTE RESPONSE SYSTEM AND DATA TRANSFER PROTOCOL, as well as U.S. Reissue Pat. No. 35,449 entitled REMOTE 2-WAY TRANSMISSION AUDIENCE POLLING AND RESPONSE SYSTEM issued to Derks, the complete disclosures both of which are hereby incorporated herein by reference. In another embodiment, communications connection 16 may be a frequency hopping spread spectrum communication connection, such as disclosed in commonly assigned U.S. patent application Ser. Nos. 10/709,527, filed May 12, 2004 by Derks et al for a WIRELESS POLLING SYSTEM USING SPREAD-SPECTRUM COMMUNICATION and 61/095,431, filed Sep. 9, 2008 by Lambrix et al for an AUDIENCE RESPONSE SYSTEM AND METHOD WITH FREQUENCY AGILE TRANSMISSION PROTOCOL, the complete disclosures of which are all hereby incorporated herein by reference.

Regardless of the specific form of communications connection 16, audience response system 10 operates by gathering information, such as user selections, from a plurality of users (i.e. audience members) who enter the information into remote response units 12a and 12b. This information is transmitted from the remote response units 12 to the base station 14. Base station 14 may include a display (not shown), or it may be coupled to a conventional computer or other device that enables the information it receives from remote response units 12 to be viewed by one or more people within the vicinity of base station 14. Base station 14 may alternatively be configured in a variety of different manners for displaying and/or processing the information it receives from the remote response units 12, such as, but not limited to: (1) projecting the information onto a large screen viewable to many, if not all, of the users of response units 12, (2) transmitting the results to another location over a computer network, such as, but not limited to, the Internet, or (3) processing the information in any other useful manner.

The manner in which the user-selection information can be entered into remote response units 12 can vary widely. In the embodiment illustrated in FIG. 1, non-linkable remote response units 12a each include a keypad 20 and a display 22. The user-selection information may be entered into the-non-linkable remote response unit 12a via pushing one or more of the buttons on keypad 20. Whichever buttons are pushed may desirably cause an image to appear on display 22 that indicates which button was pushed. For example, if a button corresponding to a letter or number is pressed, an image of the pressed letter or number may appear on display 22. After the desired button or buttons are pushed, it may be necessary to push another button, or activate another user-input, in order to transmit the information from the remote response unit 12 to the base station 14, depending upon the specific design of remote response units 12. In some embodiments, transmission of the information from remote response units 12 to the base station 14 may occur automatically after a user enters the information. In other embodiments, a separate transmission button or user-input may need to be separately activated.

It will be understood by those skilled in the art, of course, that keypad 20 is but one example of the manner in which information may be input into remote response units 12a. In lieu of, or in addition to, keypad 20, remote response units 12a may include a touch screen that is activated by a user's finger, a stylus, or other means. In other alternatives, remote response units 12a may be configured to respond to a user's voice, thereby allowing information to be entered aurally. In still other embodiments, remote response units 12a may include knobs, dials, or other mechanical structures for allowing information to be input therein.

The specific type of user selection information entered into remote response units 12 will vary from application to application. As one example, remote response units 12 may be distributed to students in a classroom wherein the students respond to one or more questions posed to them by the instructor. If the questions take on the form of a multiple choice type question, the information may comprise a number or letter corresponding to one of the answer choices available for the question. If the questions take on other forms, the information may comprise larger blocks of data, such as strings of text, or other types of data that may be enterable into remote response units 12. The instructor may also receive information via base station 14 without posing a question, such as information indicating a student does not understand a point being made, or that a student has a question, or any of a wide number of other types of information that may usefully be communicated to the instructor via remote response units 12 and base station 14.

In addition to classroom environments, audience response system 10 may be used in a wide variety of different environments. Such environments include, but are not limited to, presentation environments, retail environments, trading environments, and other types of environments where information from an audience is desired to be gathered. It will be understood that the term “audience,” as used herein, is intended to refer broadly to any group of individuals from whom information is desired to be gathered, regardless of whether the individuals in the group are physically located within the same room, building, or other structure. Thus, as noted above, an audience, as used herein, may refer to a group of individuals at a restaurant, on a trading floor, in a classroom or lecture hall, or in other environments.

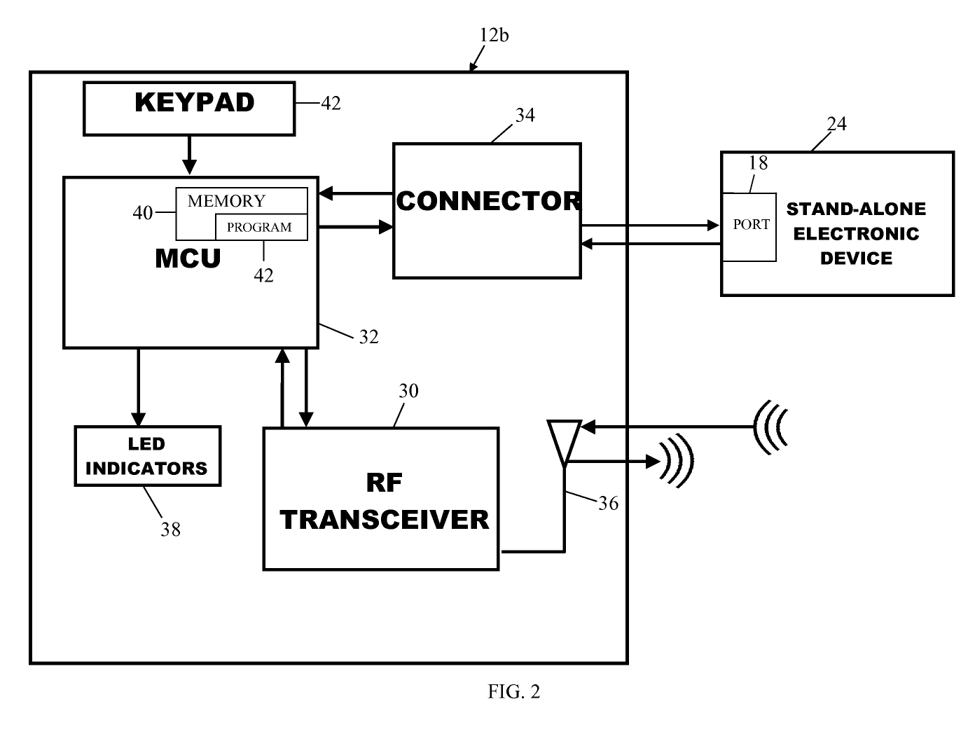

Linkable remote response units 12b, as can be seen in FIG. 1, differ from non-linkable remote response units 12a in that linkable remote response units 12b may be linked or coupled to an existing electronic device 24. When so linked, linkable remote response units 12b work in conjunction with the electronic devices 24 in the process of gathering information. For example, in the embodiment illustrated in FIG. 1, electronic device 24 is a conventional computer. Linkable remote response unit 12b is adapted to plug into an existing port 18 (FIG. 2) on the computer, such as, but not limited to, the Universal Serial Bus (USB) port of the computer. After plugging into the USB port, linkable remote response unit 12b loads a software application 42 (e.g. program) onto the computer that causes the computer to display an information input image 26 on the computer's display 28 (FIG. 1). The loading of the software application 42 may take place automatically after linkable remote response unit 12b is inserted into the port of the computer, or it may require action on the part of the user to manipulate the computer in order to load the program onto the computer. In other embodiments, the software application 42 may be loaded separately onto the host electronic device 24, such as via a CD-ROM, flash drive, network connection (including the Internet), or any other storage media that is capable of being read by the electronic device 24. When the software application 42 is loaded separately, it is not necessary for linkable remote response unit 12b to include the software application 42 in its memory.

Input image 26 may be an image of a keypad, a plurality of buttons, a touch screen, or any other type of image that graphically depicts a manner for inputting information into the computer. In the embodiment illustrated in FIG. 1, input image 26 is an image of a non-linkable remote response unit 12a. Other types of input images 26 may, of course, be used. The software application loaded onto the computer from remote response unit 12b is configured to allow the user of the electronic device 24 (e.g. computer) to input information into electronic device 24 via the input image 26. That is, if electronic device 24 is a computer, the software application may allow the user of the computer to manipulate the computer's mouse, keyboard, or other physical input structure, to cause the cursor to move over a selected portion of the image 26, such as an image of a button in image 26, and then allow the user to graphically “push” that button. That is, the user may click on the mouse when the cursor is positioned over the button image and the software application will graphically alter the image of the button such that it visually appears to have been pressed on image 26. This visual alteration may take on the form of graphic movement of the button, a change in color of the button, the appearance of the character corresponding to the button in the display portion of image 26, a combination of these forms, or any other type of forms.

After the user has graphically entered the desired information, which, as noted above, may take on different forms depending upon the application for which audience response system 10 is being used, the entered information is transmitted by electronic device 24 to linkable remote response unit 12b through the port 18 of electronic device 24. That is, if electronic device 24 is a computer and the port 18 being used is the USB port, the computer transfers the information that has been input into it to linkable remote response unit 12b through the USB port. Linkable remote response unit 12b then wirelessly transmits the information to base station 14 via a transceiver 30 (FIG. 2) contained within linkable remote response unit 12b.

The components that may be contained within one embodiment of linkable remote response units 12b are illustrated in FIG. 2. These include a controller 32, a connector 34 in communication with controller 34, and transceiver 30 with antenna 36. Linkable remote response unit 12b may also optionally include a keypad 46 and one or more LED indicators 38. In the illustrated embodiment, controller 32 is depicted as a microcontroller unit (MCU) that includes an internal memory 40 in which software application or program 42 is stored. At least a portion of internal memory 40 is non-volatile memory such that its contents (including program 42) will remain stored even in the absence of electrical power. Program 42 carries out the functions that have been described above and which will be described in greater detail below. In some embodiments, controller 32 may be replaced with a microprocessor having an external memory, or any of a number of other types of controllers, including, but not limited to, field programmable gate arrays, an Application Specific Integrated Circuit (ASIC), discrete logic, or any other suitable means for carrying out the control algorithms discussed herein.

Connector 34 is designed to couple to port 18 on electronic device 24. In one embodiment, connector 34 may be a conventional USB plug (either retractable or non-retractable) adapted to insert into a USB port on a computer, or any other type of electronic device 24 having a USB port. In other embodiments, connector 34 may be an Ethernet connector adapted to be inserted into an Ethernet port on a computer, or other type of electronic device 24. Other types of connectors may also be used. In some embodiments, linkable remote response units 12b may include a plurality of different types of connectors 34 such that linkable remote response units 12b may be plugged into ports having different physical and/or electrical configurations, such as may be found on different types of electronic devices 24.

Connector 34 allows controller 32 to communicate with electronic device 24, which may, as noted, be a computer (a desktop, laptop, notebook, or any other type of computer). Electronic device 24 may also be a variety of other types of electronic devices, such as, but not limited to, a personal digital assistant (PDA), a cell phone, a media player (e.g. ipod), or any other conventional portable electronic device. Indeed, linkable remote response units 12b may be programmed to couple to any type of electronic device 24 that includes an operating system, a display 28, and some sort of input device 44, such as, but not limited to, buttons, knobs, dials, touch screens, a mouse, a stylus, or others.

Once coupled to electronic device 24, linkable remote response unit 12b interacts with the operating system of the electronic device 24 to cause the operating system to execute program 42 on the electronic device 24. When running on electronic device 24, program 42 directs the user of the electronic device 24 to input information using one or more of the input devices 44 (FIG. 1) of electronic device 24. The manner in which program 42 directs the user to input this information can be varied. In one embodiment, described above, program 42 causes an image 26 to appear on display 28 of electronic device 24 that can be appropriately manipulated to allow information to be graphically input into electronic device 24. In other embodiments, display 28 may display textual instructions for inputting information instead of an image of an input device, or it may display a combination of text and graphics. The instructions may direct the user to enter information via the QWERTY keyboard, if electronic device 24 happens to be a computer with a QWERTY keyboard. The instructions may direct the user to enter information via other means as well. The specific content of the instructions may vary, depending upon the type of electronic device 24 to which linkable remote response unit 12b is coupled. In general, the manner in which program 42 may allow a user to enter information into electronic deice 24 is not limited.

In the embodiments where program 42 of linkable remote response unit 12b generates image 26 on display 28 of portable electronic device 24, image 26 may be an image of one of non-linkable remote response units 12a, in which case program 42 may allow a user to graphically enter information into electronic device 24 in a manner that graphically simulates the manner in which information is physically entered into remote response units 12a. In such an embodiment, program 42 effectively causes portable electronic device 24 to become a “virtual” remote response unit 12a that presents the user with a simulated way of entering all of the information that is able to be entered into remote response units 12a, but without necessarily providing all, or any, of the physical input structures (e.g. buttons) that may be incorporated into non-linkable remote response units 12a. This enables, if desired, linkable remote response unit 12b to be a scaled down version of one of the nonlinkable remote response units 12a in that remote response unit 12b may include fewer buttons (if any) than remote response unit 12a, or it may not include a display screen 22 like remote response units 12a.

Linkable remote response units 12a may assume such a scaled down configuration regardless of the specific manner in which program 42 enables a user of portable electronic device 24 to enter information. That is, program 42 allows linkable remote response units 12b to utilize the input features and/or display features of the host electronic device 24 such that those input features and/or display features do not necessarily have to be included on linkable remote response unit 12b, or they may be reduced in size or number when compared to non-linkable remote response units 12a. Thus, linkable remote response units 12b may not include keypad 20, or they may include a keypad (e.g. keypad 46) that includes fewer buttons than keypad 20 of non-linkable remote response units 12a. Similarly, linkable remote response units 12b may not include a display 22, or they may include a smaller display than that of non-linkable remote response units 12a. These smaller or eliminated features may allow linkable remote response units 12b to be physically smaller than non-linkable remote response units, and also may allow them to be manufactured with less expense than non-linkable remote response units 12a. However, by utilizing the keypad, display, and/or other input resources of the host electronic device 24, linkable remote response units 12b may allow for the same functionality, or an even greater functionality, than that of non-linkable remote response units 12a.

This potential expanded functionality arises because the display and input structures of the host electronic device 24 may be greater than those of non-linkable remote response units 12a. That is, in some embodiments, non-linkable remote response units 12a may not include a full keyboard containing all of the letters of the alphabet, or the full ten numeric digits. However, by coupling a linkable remote response unit 12b to a host electronic device 24 having such keys, the linkable remote response unit 12b will effectively include the input and display features of the host electronic device 24, which may be substantially greater than those found on non-linkable remote response units 12a.

Linkable remote response units 12b may be configured to operate in conjunction with different types of operating systems such that they can be coupled, via connector 34, to computers having different types of operating systems (e.g., Windows®, Linux®, Mac OS®, Solaris®, etc), as well as other types of portable electronic devices 24 that may include different operating systems (e.g. a mobile operating system such as, but not limited to, Windows Mobile®). Linkable remote response units 12b thus may be linked, via connector 34, to a wide variety of different electronic devices 24. The manner for carrying out such interoperability would be known to one skilled in the art of computer programming and need not be described herein.

Transceiver 30 of linkable remote response units 12b may be a radio frequency (RF) transceiver, such as is illustrated in FIG. 2, or it may be a transceiver that utilizes wireless signals outside of the radio frequency spectrum. In one embodiment, transceiver 30 may operate at a frequency of 2.4 gigahertz, although other frequencies can, of course, be used. The communication algorithms followed by linkable remote response units 12b may, in some embodiments, be the same as those followed by non-linkable remote response units 12a.

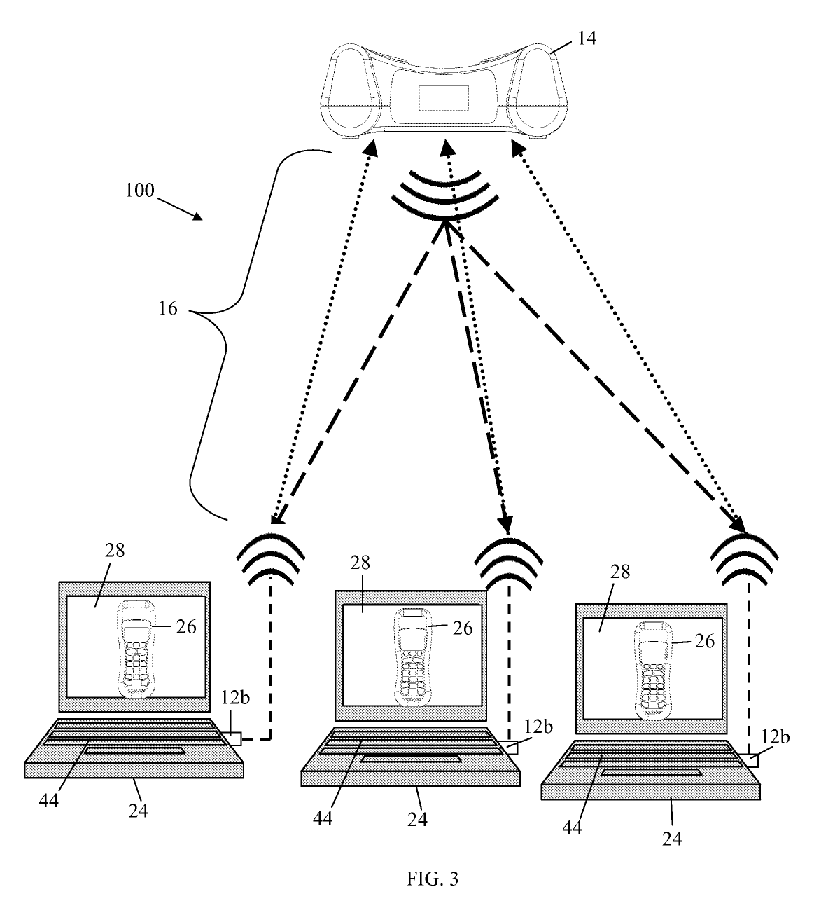

The embodiment of audience response system 10 illustrated in FIG. 1 includes a plurality of non-linkable remote response units 12a, as well as a single linkable remote response unit 12b. It will be understood, of course, that the ratio between non-linkable and linkable remote response units 12 in a given audience response system can be varied. Indeed, in an alternative embodiment depicted in FIG. 3, audience response system 100 is comprised solely of linkable remote response units 12b, and contains no nonlinkable remote response units 12a. While audience response system 100 is depicted as comprising identical host electronic devices 24, it will be understood that neither audience response system 100, nor audience response system 10, need be comprised of remote response units 12b that are coupled to a the same type of host electronic device 24. That is, audience response systems 100 and 100 may include some linkable remote-response units 12b that are coupled to a computer, some that are coupled to a PDA, and/or some that are coupled to a cell phone. The mix of host electronic devices 24 is not limited.

In either of the audience response systems 10 and 100, non-linkable remote response units 12a may be conventional audience response units, such as, for example, but not limited to, those marketed under the Reply® brand by the Fleetwood Group, Inc. the assignee of the present application-which has a principal place of business in Holland, Mich. These include the Reply® Mini Wireless Keypad Model CRS5000, the Reply® IQ Wireless Keypad Model IQK1000, as well as others. Other types of non-linkable remote response units 12a may also be used.

Both linkable and non-linkable remote response units 12b and 12a may include one or more batteries for supplying electrical energy to themselves. The batteries may be rechargeable or non-rechargeable. Linkable remote response units 12b may be configured such that, if coupled to a host electronic device via a port 18 that transfers power (e.g. a USB port), a rechargeable battery contained within linkable remote response unit 12b is recharged with that power while coupled to the host electronic device 24. Linkable remote response unit 12b may alternatively be configured such that it does not contain a battery, but instead draws electrical power to whatever host electronic device 24 it is attached to, such as through a USB port, or via any other suitable connection that allows the electronic device 24 to supply power to unit 12b

While the ability of linkable remote response units 12b to be linked to a host electronic device 24 via connector 34 may obviate the need for a keypad or other input devices on the remote response unit 12b itself, linkable remote response units 12b may nevertheless still include a keypad 46 having a plurality of buttons (or other structures) that enable information to be directly entered into remote response units 12b via the keyboard 46. Such directly entered information may then be transmitted by transceiver 30 to base station 14.

Optional LED indicators 38, if included on linkable remote response units 12b, may be illuminated in several situations. One such LED may light up when connector 34 of linkable remote response unit 12b has successfully been inserted into port 18 of the host electronic device 24. The same, or another LED, may light up when information is being transmitted to base station 14, or when information is received back from base station 14. The same, or another LED, may also light up every time a key on linkable remote response unit 12b is pressed, or every time a virtual key in the image 26 of a button on portable electronic device 24, is virtually pressed.

Linkable remote response units 12b may also be configured such that they can be transported to different environments having separate base stations 14 and automatically join whichever base station 14 happens to be in the closest vicinity, such as disclosed in commonly assigned patent application Ser. No. 11/163,008, filed Sep. 30, 2005 by Buehler et al for a RESPONSE SYSTEM AND METHOD WITH A DYNAMIC PERSONALITY ASSIGNMENT; Ser. No. 12/127,254, filed May 27, 2008 by Buehler et al for an AUDIENCE RESPONSE SYSTEM AND METHOD WITH MULTIPLE BASE UNIT CAPACITY; and Ser. No. 12/191,484 filed Aug. 14, 2008 by Buehler et al for RESPONSE SYSTEM AND METHOD WITH DYNAMIC PERSONALITY ASSIGNMENT, the complete disclosures of which are all hereby incorporated herein by reference. In that manner, for example, if multiple audience response systems 10 are being used in different classrooms, a student can carry his or her linkable remote response unit 12b with him to the different classes and the unit 12b will automatically communicate with whichever base station 14 is within the closest vicinity to unit 12b. This automatic joining ability is useful in other situations besides classroom environments.

As has been noted above, communications between base station 14 and remote response units 12a and 12b may take on a variety of forms. Such communication may be synchronous or asynchronous. In some embodiments, the communication between base station 14 and remote response units 12a and 12b is bidirectional. The nature, timing, and content of the signals transmitted from base station 14 to one or more remote response units 12a and/or 12b may take on the forms described in the commonly assigned patents and applications discussed above and incorporated herein by reference. In one embodiment, remote response units 12a and 12b may be configured to repetitively transmit the user information to base station 14 until base station 14 transmits an acknowledgement that it has received the user information. Other protocols may also be used. Such protocols may include time division multiplexing. In some embodiments, the protocols may allow more than a thousand remote response units to transfer their user information to base station 14 within a second or less without interference between the signals from the remote response units 12.

While the present invention has been described herein in terms of various embodiments, it will be understood by those skilled in the art that the invention is capable of being implemented in a wide variety of other embodiments beyond those described and illustrated herein. Accordingly, the scope of the invention is intended to be limited only by the scope of the appended claims, as interpreted according to the principles of patent law, including the doctrine of equivalents.

What is claimed is:

1. A wireless response system for communicating user selections from an audience comprising:
a base unit adapted to receive the user selections; and
a plurality of remote response units adapted to wirelessly communicate the user selections to said base unit, wherein at least one of said remote response units includes:
(a) a connector adapted to couple to a port of an electronic device having a display screen, an operating system, and an input device;
(b) a program adapted to be loaded onto the electronic device through said port and to run on the operating system of the electronic device, said program adapted to allow a user to input a user selection into the electronic device via said input device and to transfer said user selection to said at least one remote response unit; and
(c) a wireless transceiver for communicating wirelessly with said base unit, said at least one remote response unit adapted to transmit the user selection to said base unit through said transceiver.

2. The system of claim 1 wherein said connector is a Universal Serial Bus (USB) connector and the port on the electronic device is a USB port.

3. The system of claim 1 wherein said electronic device is one of a personal computer, a notebook computer, a laptop computer, a personal digital assistant (PDA), and a cell phone.

4. The system of claim 1 wherein said at least one remote response unit includes a plurality of buttons adapted to allow a user to enter user selections into said at least one-remote response unit and transmit the entered user selections to said base station while said connector is decoupled from the port of the electronic device.

5. The system of claim 1 wherein said program is further adapted to generate an image of a keypad on the display of the electronic device wherein said image of said keypad includes a button, said program further adapted to allow a user of the electronic device to enter user selections by graphically manipulating the button on the image of the keypad.

6. The system of claim 1 wherein said at least one remote response unit includes an LED for indicating when said transceiver is transmitting the user selections to the base station.

7. The system of claim 1 wherein said at least one remote response unit is further adapted to couple to a plurality of different types of electronic devices wherein said plurality of different types of electronic devices include a first set of devices having a first operating system and a second set of devices having a second operating system different from said first operating system.

8. The system of claim 1 wherein said at least one remote response unit is adapted to transmit the user selection using a frequency-hopping spread spectrum method.

9. The system of claim 1 wherein at least another one of said plurality of remote response units includes a keypad for entering user selections and a transceiver for transmitting the user selections to the base unit, wherein said another one of said remote response units does not include said program adapted to be loaded onto the electronic device.

10. For a wireless response system for processing user selections transmitted to a base station from an audience member, a remote response unit comprising:
a connector adapted to couple to a port of an electronic device having a display screen, an operating system, and an input device;
a program adapted to be loaded onto said electronic device through said port and to run on the operating system of the electronic device, said program adapted to allow the audience member to input a user selection into the electronic device via said input device and to transfer said user selection to said remote response unit; and
a wireless transceiver for communicating wirelessly with said base unit, said remote response unit adapted to transmit the user selection to said base unit through said transceiver.

11. The system of claim 10 wherein said connector is a Universal Serial Bus (USB) connector and the port on the electronic device is a USB port.

12. The system of claim 11 wherein said electronic device is one of a personal computer, a notebook computer, a laptop computer, a personal digital assistant (PDA), and a cell phone.

13. The system of claim 12 wherein said program is further adapted to generate an image of a keypad on the display of the electronic device wherein said image of said keypad includes a button, said program further adapted to allow the audience member to enter the user selection by graphically manipulating the button on the image of the keypad.

14. The system of claim 13 wherein said remote response unit includes a plurality of buttons adapted to allow the audience member to enter the user selection into said remote response unit and transmit the entered user selection to said base station while said connector is decoupled from the port of the electronic device.

15. A method for communicating user selections from an audience to a base unit comprising:
providing a remote response unit adapted to wirelessly communicate user selections to said base unit;
coupling said remote response unit to a port of an electronic device having a display screen, an operating system, and an input device;
loading a program from said remote response unit onto said electronic device through said port;
inputting a user selection into the electronic device via said input device;
transferring said user selection to said remote response unit; and
wirelessly transmitting said user selection from said remote response unit to said base unit.

16. The method of claim 15 further including:
generating an image of a keypad on the display of the electronic device wherein said image of said keypad includes a button; and
graphically manipulating said button to enter the user selection into said electronic device.

17. The method of claim 16 further including:
providing a plurality of buttons on said remote response unit;
entering the user selection into said remote response unit; and
transmitting the entered user selection to said base station while said remote response unit is decoupled from the port of the electronic device.

18. The method of claim 15 wherein said connector is a Universal Serial Bus (USB) connector and the port on the electronic device is a USB port.

19. The method of claim 16 wherein said electronic device is one of a personal computer, a notebook computer, a laptop computer, a personal digital assistant (PDA), and a cell phone.

20. A wireless response system for communicating user selections from an audience comprising:
a base unit adapted to receive the user selections;
a plurality of remote response units adapted to wirelessly communicate the user selections to said base unit, wherein at least one of said remote response units includes:
(a) a connector adapted to couple to a port of an electronic device having a display screen, an operating system, and an input device; and
(b) a wireless transceiver for communicating wirelessly with said base unit, said at least one remote response unit adapted to transmit the user selection to said base unit through said transceiver; and
a program adapted to be executed on the electronic device, said program adapted to generate an image of a keypad on the display screen of the electronic device, wherein said image of said keypad includes a button and said program is further adapted to allow a user to enter the user selection by graphically manipulating the button on the image of the keypad.

21. The system of claim 20 wherein said program is loaded onto said electronic device via a device separate from said at least one of said remote response units.

22. The system of claim 20 wherein said program is stored in a memory on said at least one of said remote response units and loaded onto said electronic device through said connector.
